(19) United States
(12) Patent Application Publication
(10) Pub. No.: US 2011/0104483 A1
(43) Pub. Date: May 5, 2011

(54) CURABLE ADHESIVE SHEET

(76) Inventors: Kotaro Shinozaki, Kanagaw-pref. (JP); Yorinobu Takamatsu, Kanagawa-pref (JP)

(21) Appl. No.: 13/000,078

(22) PCT Filed: Jun. 25, 2009
(86) PCT No.: PCT/US09/48599

§ 371 Date: Dec. 20, 2010

(30) Foreign Application Priority Data
Jun. 30, 2008 (JP) 2008-170828

(51) Int. Cl. C09J 7/02; B32B 7/12; B32B 27/00

(52) U.S. Cl. 428/347; 428/354; 428/423.1

(57) ABSTRACT

To provide an adhesive sheet having both low temperature impact resistance and high temperature adhesiveness. An adhesive sheet is provided, comprising: a core layer having first and second major surfaces, the core layer containing a polymer having a urethane acrylate unit and the glass transition temperature (Tg) of the polymer being less than 0° C.; and a first curable adhesive layer laminated on the first major surface of the core layer.

### TECHNICAL FIELD

The present disclosure relates to an adhesive sheet having low temperature impact resistance and high temperature adhesiveness.

### BACKGROUND ART

A liquid urethane adhesive is being widely used for the purpose of adhering parts for fixing an automotive side glass or rear glass or the like to a vehicle body. However, this adhesive is generally moisture-curable and takes a very long time until complete curing, and a clamp is required for temporarily fixing the glass until the adhesive is cured. Also, a spacer for controlling the coating thickness of the adhesive needs to be used. Furthermore, in order to remove the excess adhesive, a skill is required of the operator.

On the other hand, an epoxy resin-containing heat-curable adhesive tape is known as an adhesive in the form of a tape for a substrate such as glass. Unlike a urethane adhesive, this adhesive tape is advantageous in that curing can be attained in a short time by heating, control of the coating thickness is easy, removal of excess adhesive after curing is not necessary and in turn, good workability and less variation in the finished quality are ensured.

In Kohyo (National Publication of Translated Version) No. 2001-518408 (WO99/16618), which “relates to establishing a seal between two substrates, particularly between two substrates where at least one of the substrates is glass”, there is described “an article comprising (a) a conformable, compressible and melt flow-resistant foam core layer having first and second major surfaces, and (b) a thermosettable sealant layer on the first major surface of the core layer, the sealant layer having a surface available for contacting a substrate”, and this is usable as an adhesive tape for a substrate such as glass.

### DISCLOSURE OF THE INVENTION

However, the epoxy resin-containing heat-curable adhesive tape is sometimes difficult to apply to automotive usage and the like requiring impact resistance at low temperatures, because after curing the tape, the cured resin enters a glass state at low temperatures, for example, at 0° C. or −30° C., and the impact resistance decreases.

In order to improve the low temperature impact resistance, techniques of dispersing a rubber or elastomer component in an adhesive composition have been heretofore studied, but sufficiently high low temperature impact resistance is not yet achieved. Furthermore, in the adhesive composition prepared using such a technique, the cohesive force of the cured resin decreases under high temperature conditions, for example, at 80° C., causing cohesion failure, and the shear bond strength decreases in some cases.

In some embodiments, the present disclosure provides an adhesive sheet having both low temperature impact resistance and high temperature adhesiveness and usable over a wide temperature range.

The present disclosure provides an adhesive sheet comprising: a core layer having first and second major surfaces, the core layer containing a polymer having a urethane acrylate unit and the glass transition temperature (Tg) of the polymer being less than 0° C.; and a first curable adhesive layer stacked on the first major surface of the core layer.

According to the present disclosure, an adhesive sheet usable over a wide temperature range can be obtained, ensuring low temperature impact resistance under low temperature conditions and at the same time, exerting high temperature adhesiveness because the core layer is prevented from or reduced in the cohesion failure under high temperature conditions.

Incidentally, the description above should not be construed as disclosing all embodiments of the present invention and all advantages related to the present invention.

### BRIEF DESCRIPTION OF THE DRAWINGS

FIG. 1 is a cross-sectional view of an adhesive sheet according to one embodiment of the present disclosure.

[FIG. 2] An adhesive sheet according to another embodiment of the present disclosure, where a primer layer is provided between the curable adhesive layer and the core layer.

[FIG. 3] An adhesive sheet according to still another embodiment of the present disclosure, where the curable adhesive layer is laminated on both surfaces of the core layer.

[FIG. 4] An adhesive sheet according to yet still another embodiment of the present disclosure, where a release liner is provided on the curable adhesive layer.

FIG. 5 is a schematic view of a testing device used for the low temperature impact resistance test.

### BEST MODE FOR CARRYING OUT THE INVENTION

Representative embodiments of the present invention are described in detail below for the purpose of illustration, but the present invention is not limited to these embodiments.

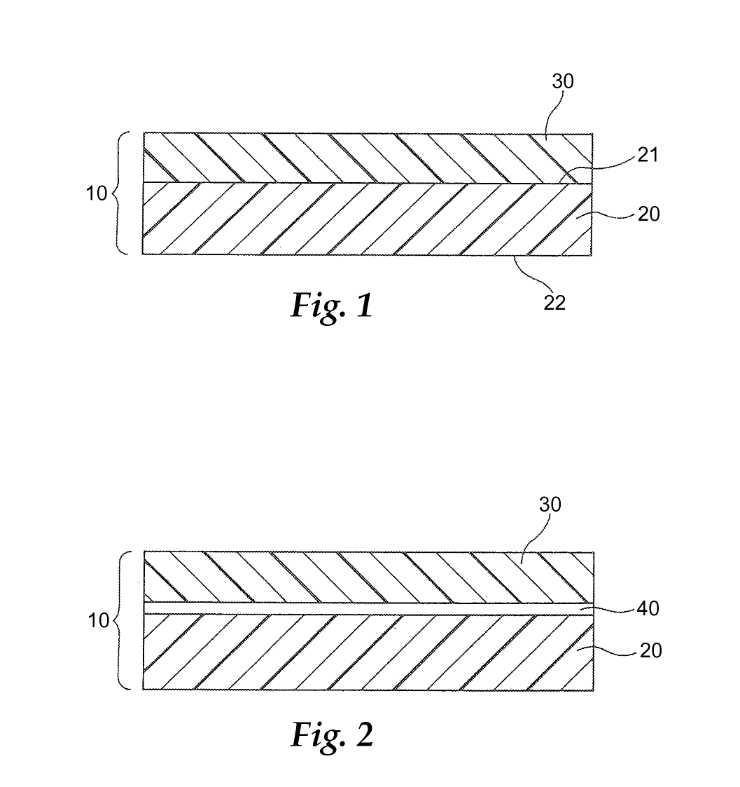

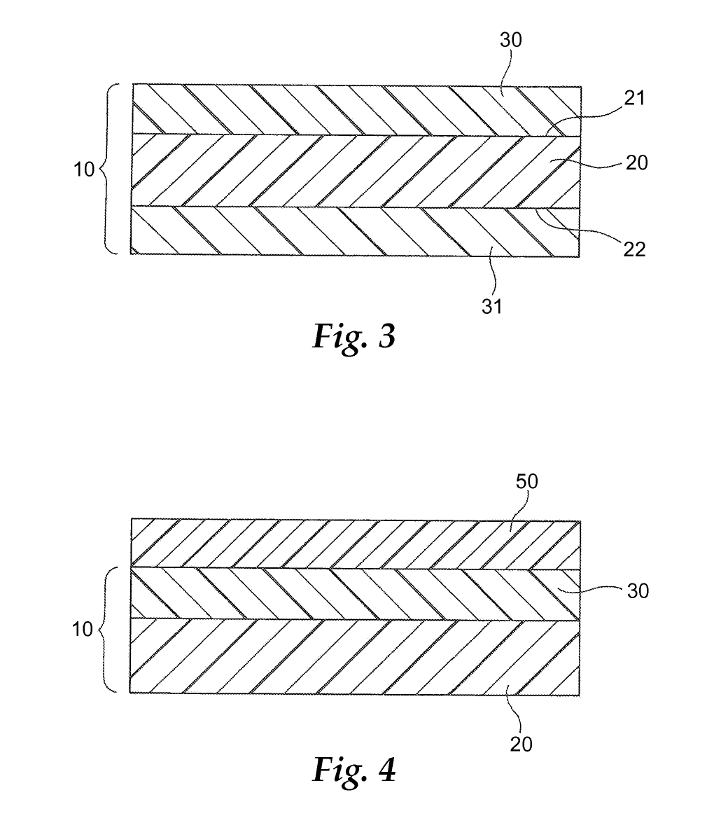

FIG. 1 is a cross-sectional view of the adhesive sheet 10 according to one embodiment of the present disclosure. The adhesive sheet 10 shown in FIG. 1 is a laminate of a core layer 20 and a curable adhesive layer 30 and comprises: a core layer 20 having first and second major surfaces 21 and 22, the core layer 20 containing a polymer having a urethane acrylate unit and the glass transition temperature (Tg) of the polymer being less than 0° C.; and a first curable adhesive layer 30 stacked on the first major surface 21 of the core layer. The polymer having a urethane acrylate unit and having Tg of less than 0° C. allows for minimized reduction of the viscoelastic characteristics even at a low temperature, because the temperature at which the polymer enters a glass state is low. At the same time, such a polymer has cohesive force high enough to prevent the cohesion failure at a high temperature. A core layer obtained using such a polymer is combined with a curable adhesive layer, whereby an adhesive sheet as a whole having both low temperature impact resistance and high temperature adhesiveness can be produced.

The glass transition temperature Tg as referred to herein is measured as follows. A 0.5 mm-thick polymer sheet sample is measured in a temperature range from −60° C. to 200° C. (temperature rising rate: 5.0° C./min) by using RSA-III manufactured by Rheometric Scientific, Inc. under the conditions of Mode: Tension and Frequency: 1.0 Hz, and the peak temperature of loss tangent tan δ (=loss modulus E″/storage modulus E′) is defined as the glass transition temperature Tg.

According to another embodiment of the present disclosure, as regards the viscoelastic characteristics of the polymer contained in the core layer, the storage modulus E′ of the polymer may be from about 5.0×10⁵ to about 3.0×10⁸ Pa at 0° C. and from about 5.0×10⁵ to about 3.0×10⁸ Pa at 80° C. and at the same time, the loss tangent tan δ (=loss modulus E″/storage modulus E′) of the polymer may be about 0.15 or more at 0° C. and about 0.25 or less at 80° C. In still another embodiment, the storage modulus E′ of the polymer may be from about 1.0×10⁶ to about 3.0×10⁸ Pa at 0° C. and from about 8.0×10⁵ to about 3.0×10⁸ Pa at 80° C. and at the same time, the loss tangent tan δ of the polymer may be about 0.20 or more at 0° C. and about 0.20 or less at 80° C.

In the case where the adhesive sheet is desired to have sufficient low temperature impact resistance also in a severer low-temperature environment, for example, at −20° C. or a temperature lower than that, in addition to the above-described requirements for viscoelastic characteristics, the storage modulus E′ of the polymer may be from about 1.0×10⁶ to about 3.0×10⁸ Pa at −30° C. and at the same time, the loss tangent tan δ of the polymer may be about 0.30 or more at −30° C.

In general, the low temperature impact resistance of the adhesive sheet relies on the phenomenon that when impact energy is imposed on the adhesive sheet at a low temperature, the constituent material of the adhesive sheet is deformed and the impact energy is thereby dispersed or absorbed. Accordingly, under low temperature conditions, when the constituent material of the adhesive sheet can deform sufficiently to disperse or absorb the imposed impact energy while keeping the cohesive force enough to hold the shape, the adhesive sheet can have low temperature impact resistance. From this standpoint, as regards the viscoelastic characteristics of the polymer contained in the core layer, it is advantageous for enhancing the low temperature impact resistance of the adhesive sheet that at a low temperature, for example, at 0° C., the storage modulus E′ is low and the tan δ is high.

On the other hand, in the case of an adhesive sheet which is exposed to high-temperature conditions corresponding to usage in the scorching outdoor heat, particularly, such as an adhesive sheet for assembling a car, when the constituent material of the adhesive sheet has high cohesive force and does not easily cause cohesion failure at that temperature, high shear bond strength can be maintained. From this standpoint, as regards the viscoelastic characteristics of the polymer contained in the core layer, it is advantageous for enhancing the shear bond strength of the adhesive sheet that at a high temperature, for example, at 80° C., the storage modulus E′ is high and the tan δ is low as compared with the constituent material of a conventional adhesive sheet in general, such as urethane foam.

The polymer having a urethane acrylate unit can be generally obtained by reacting a polyfunctional isocyanate compound with a polyol compound having a polymeric backbone and reacting the obtained terminal isocyanate-modified polymer with a (meth)acrylate having a functional group capable of reacting with the isocyanate group, such as hydroxyl group. As regards the terms “(meth)acryl” and “(meth)acrylate” used herein, the former means acryl and methacryl, and the latter means acrylate and methacrylate.

The polyol compound having a polymeric backbone constitutes the polymeric backbone of the polymer having a urethane acrylate unit, and a polyol compound generally used for polyurethane may be used. Out of the polyol compounds, there may be used, for example, a polyether polyol compound such as polyethylene glycol, polypropylene glycol and polytetramethylene glycol; a polyester polyol compound such as polyester polyol obtained, for example, by reacting a polybasic acid (e.g., phthalic acid, adipic acid, maleic acid) with a polyhydroxy compound (e.g., ethylene glycol, propylene glycol, butylene glycol, diethylene glycol, trimethylolpropane, pentaerythritol), or polycaprolactone polyol; a polycarbonate polyol compound such as 1,6-hexanediol carbonate polyol; and a combination thereof. In a certain embodiment, out of these polyol compounds, a polyether polyol such as polyethylene glycol, polypropylene glycol and polytetramethylene glycol may be used and in particular, polypropylene glycol may be used.

Examples of the polyfunctional isocyanate compound include, but are not limited to, 2,4-tolylene diisocyanate, 1,3-xylene diisocyanate, hexamethylene diisocyanate, 4,4′-diphenylmethane diisocyanate and isophorone diisocyanate.

Examples of the (meth)acrylate having a functional group capable of reacting with the isocyanate group include, but are not limited to, a hydroxyl group-containing (meth)acrylate or (meth)acrylic acid, such as 2-hydroxyethyl (meth)acrylate, 2-hydroxypropyl (meth)acrylate, 4-hydroxybutyl (meth)acrylate, caprolactone-modified (meth)acrylate, polyethylene glycol (meth)acrylate and polypropylene glycol (meth)acrylate.

The polymer having a urethane unit can constitute the core layer of the adhesive sheet in a state of the (meth)acrylic group contained in the polymer being polymerized. The polymerization of the (meth)acrylic group can be performed by a generally known method such as thermal polymerization or radiation polymerization. In the thermal polymerization, a thermal polymerization initiator such as azo-based polymerization initiator (e.g., 2,2′-azobisisobutyronitrile), peroxide-based polymerization initiator (e.g., dibenzoyl peroxide, tert-butyl hydroperoxide) and redox-based polymerization initiator is mixed to the constituent raw materials of the polymer and the mixture is heated, thereby effecting the polymerization. In the radiation polymerization, a photopolymerization initiator such as benzoyl alkyl ether, acetophenone, benzophenone, benzyl methyl ketal, hydroxycyclohexyl phenyl ketone, 1,1-dichloroacetophenone and 2-chlorothioxanthone is added to the constituent raw materials of the polymer, and the mixture is irradiated with radiation such as ultraviolet ray and electron beam, thereby effecting the polymerization. One polymerization initiator may be used alone, or two or more kinds of polymerization initiators may be used in combination. The polymerization initiator may be added in a general amount. In the case of photopolymerization initiator, a sensitizer, etc., may be further used in combination with the photopolymerization initiator.

According another embodiment of the present disclosure, the polymer having a urethane acrylate unit may further contain a polar group-containing unit. By incorporating a polar group-containing unit into the polymer, the interlayer adhesive force between the core layer and the curable adhesive layer can be more increased. The polar group-containing unit can be introduced into the polymer by reacting a polar group-containing monomer with a (meth)acrylic group contained in the urethane acrylate unit. Examples of the monomer constituting the polar group-containing unit include a hydroxyl group-containing monomer such as 2-hydroxyethyl (meth)acrylate, 2-hydroxypropyl (meth)acrylate, 4-hydroxybutyl (meth)acrylate, caprolactone-modified (meth)acrylate, polyethylene glycol (meth)acrylate and polypropylene glycol (meth)acrylate; a carboxyl group-containing monomer or an anhydride thereof, such as (meth)acrylic acid, maleic acid, fumaric acid and itaconic acid; and a copolymerizable monomer having a polar group (e.g., amide group, amino group, epoxy group, nitrile group, ester group, aromatic group), such as N-vinylpyrrolidone, N-vinyl caprolactone, acryloylmorpholine, (meth)acrylamide, N,N-dimethylacrylamide, N,N-dimethylaminoethyl (meth)acrylate, N,N-diethylaminoethyl (meth) acrylate, N,N-dimethylaminopropyl (meth)acrylamide, glycidyl (meth)acrylate, phenoxyethyl (meth)acrylate, acrylonitrile, vinyl acetate and styrene. For example, out of these polar group-containing monomers, a monomer having a functional group capable of forming a hydrogen bond, such as hydroxyl group, carboxyl group, amino group and amide group, can be used. In particular, the hydroxyl group-containing monomer, such as 2-hydroxyethyl (meth)acrylate, 2-hydroxypropyl (meth)acrylate and 4-hydroxybutyl (meth)acrylate can be used. In the case where such a polar group-containing unit is contained in the polymer, when the content thereof is about 20% by weight or more based on the weight of the polymer, the polymer can effectively contribute to the enhancement of interlayer adhesive force between the core layer and the curable adhesive layer. In another embodiment, the content may be about 30% by weight or more. On the other hand, when the content of the polar group-containing unit is about 70% by weight or less, the polymer can maintain the cohesive force high enough to endure the shear force in normal usage. In another embodiment, the content may be about 60% by weight or less.

Also, the polymer having a urethane acrylate unit may contain a unit derived from other optional monomers within the range of not impairing the above-described characteristic features. Examples of the optional monomer include, but are not limited to, an alkyl acrylate such as butyl acrylate, 2-ethylhexyl acrylate, isooctyl acrylate and cyclohexyl acrylate; and a polyfunctional (meth)acrylate monomer such as hexanediol di(meth)acrylate, polyethylene glycol di(meth)acrylate, trimethylolpropane tri(meth)acrylate and pentaerythritol tri(meth)acrylate. Such a monomer can also be introduced into the polymer, similarly to the above-described polar group-containing monomer, by reacting the monomer with a (meth)acrylic group in the urethane acrylate unit.

The weight average molecular weight of the thus-obtained polymer is generally about 400 or more or about 1,000 or more and is about 100,000 or less or about 50,000 or less.

Furthermore, an optional additional component such as inorganic filler (e.g., silica gel, aluminum oxide, titanium dioxide), antioxidant and colorant may be mixed in the polymer having a urethane acrylate unit.

The low temperature impact resistance and high temperature adhesiveness of the adhesive sheet are mainly governed by the kind and viscoelastic characteristics of the polymer contained in the core layer and not greatly affected by the kind of the curable adhesive layer. Accordingly, various kinds of adhesive materials can be used as the curable adhesive layer combined with the core layer. The various curable adhesive layers may be used that exhibit satisfactory interfacial adhesive force to an adherend such as glass or coated plate at the curing and ensures sufficiently high cohesive force in the use temperature range not to readily cause cohesion failure. For example, when the curable adhesive layer used over a wide temperature range in the automotive usage, etc., is cured, the cured adhesive layer generally has a storage modulus E′ of about 1.0×10⁶ Pa or more and a loss tangent tan δ of about 0.3 or less at 80° C.

Examples of the adhesive material for use in the curable adhesive layer include a mixture of an epoxy resin and a polyacrylate described in U.S. Pat. No. 5,086,088 (Kitano et al.); a mixture of an epoxy resin and a semi-crystalline polymer such as polyester described in Kohyo 2001-518408; and a urethane-based reactive hot-melt composition.

The mixture of an epoxy resin and a polyacrylate is a photopolymerization reaction product of a composition containing (i) a polymerizable prepolymeric or monomeric syrup of a (meth)acrylic acid ester, (ii) a crosslinking comonomer as an optional component, (iii) an epoxy resin, (iv) a photopolymerization initiator, and (v) a heat-activatable curing agent for the epoxy resin; or a thermal polymerization reaction product of a composition containing (i) a polymerizable prepolymeric or monomeric syrup of a (meth)acrylic acid ester, (ii) a crosslinking comonomer as an optional component, (iii) an epoxy resin, (iv) a thermal polymerization initiator, and (v) a light-activatable curing agent for the epoxy resin.

The polymerizable prepolymeric or monomeric syrup of a (meth)acrylic acid ester contains a prepolymer obtained by partially polymerizing an alkyl acrylate such as butyl acrylate, hexyl acrylate, 2-ethylhexyl acrylate, octyl acrylate, isooctyl acrylate, decyl acrylate and dodecyl acrylate, with a copolymerizable polar monomer such as N,N-dimethylamide, N-vinylpyrrolidone, N-vinyl caprolactam, N-vinyl piperidine and acrylonitrile, or contains such monomers. The ratio between the alkyl acrylate and the copolymerizable polar monomer is in general approximately from 95:5 to 50:50 on the weight basis.

Examples of the crosslinking comonomer as an optional component include a polyfunctional acrylate such as 1,6-hexanediol diacrylate, and a triazine-based cross-linking agent such as triazine isocyanurate. The content of the crosslinking comonomer is generally about 5 parts by weight or less per 100 parts by weight of the polymerizable syrup.

The epoxy resin is selected from compounds containing two or more epoxy groups derived from a glycidyl group, a cyclohexene oxide group, etc., per one molecule, and examples thereof include a phenolic epoxy resin, a bisphenol epoxy resin and a halogenated bisphenol epoxy resin. In particular, as for the bisphenol epoxy resin, a diglycidyl ether of bisphenol A can be used. The content of the epoxy resin may be generally from about 50 to about 300 parts by weight, or from about 60 to about 250 parts by weight, per 100 parts by weight of the polymerizable syrup.

Examples of such an epoxy resin include a bisphenol A-type epoxy resin (available, for example, under the trade names of EPON SU-8, EPON SU-2.5, EPON 828, EPON 1004F and EPON 1001F (Shell Chemical Co.), and trade names of DER-332 and DER-334 (Dow Chemical Co.)); a bisphenol F-type epoxy resin (for example, Araldite GY281 produced by Ciba Japan); a flame-retardant epoxy resin (for example, a brominated bisphenol-type epoxy resin available under the trade name of DER-542 from Dow Chemical Co.); a hydrogenated bisphenol A-epichlorohydrin type epoxy resin (for example, EPONEX 1510 produced by Shell Chemical Co.); and a polyglycidyl ether of phenol-formaldehyde novolak resin (for example, DEN-431 and DEN-438 produced by Dow Chemical Co.).

The (meth)acrylic group contained in the prepolymeric or monomeric syrup in the mixture above is photopolymerized or thermally polymerized, whereby a curable adhesive layer having an appropriate viscosity can be formed. As a result of polymerization of the (meth)acrylic group, the curable adhesive layer may lose the flowability, for example, at room temperature. Examples of the photopolymerization initiator which can be used include benzoyl alkyl ether, acetophenone, benzophenone, benzyl methyl ketal, hydroxycyclohexyl phenyl ketone, 1,1-dichloroacetophenone and 2-chlorothioxanthone, and specific examples thereof include Irgacure 651 (2,2-dimethoxy-1,2-diphenylethan-1-one) produced by Ciba Japan and Darocur 1173 produced by Merck Japan Ltd. Examples of the thermal polymerization initiator include an azo-based polymerization initiator (e.g., 2,2′-azobisisobutyronitrile), a peroxide-based polymerization initiator (e.g., dibenzoyl peroxide, tert-butyl hydroperoxide), and a redox-based polymerization initiator.

The surface of the curable adhesive layer formed from an epoxy resin-polyacrylate mixture is put into contact with the attaching surface of an adherend and then, the light-activatable curing agent or heat-activatable curing agent is activated to cure the epoxy resin-polyacrylate mixture, whereby the curable adhesive layer can be adhered to the adherend. Suitable examples of the light-activatable curing agent include an aromatic iodonium complex salt, an aromatic sulfonium complex salt and a metallocene salt, and specific examples of such a light-activatable curing agent include FX-512 (produced by 3M Company) as an aromatic sulfonium complex salt, CD-1010 (produced by Sartomer) as an aromatic sulfonium complex salt, CD-1012 (produced by Sartomer) as a diaryl iodonium complex salt, UVI-6974 (produced by Union Carbide Corp.) as an aromatic sulfonium complex salt, and Irgacure 261 (produced by Ciba Japan) as a metallocene complex salt. Also, a photosensitizer may be used in combination with the light-activatable curing agent, and examples of the photosensitizer include pyrene, fluoroanthrene, benzil, chrysene, p-terphenyl, acenaphthene, phenanthrene, biphenyl and camphorquinone. Also, suitable examples of the heat-activatable curing agent include amine-, amide-, Lewis acid complex- and anhydride-based curing agents. In particular, an amine-based curing agent such as dicyandiamide, imidazole and polyamine salt can be used, and examples of such a heat-activatable curing agent include a dicyandiamide-based curing agent available under the part No. EH3636AS from Adeka Corp. Furthermore, in order to achieve the curing at a lower temperature and/or in a shorter time, a curing accelerator may be used in combination with the heat-activatable curing agent, and in particular, an imidazole compound can be used. Examples of the curing accelerator include 2,4-diamino-6-[2′-methylimidazolyl-(1′)]-ethyl-s-triazine (available under the trade name of 2MZ-A-PW from Shikoku Chemicals Corp.) and 2-phenyl-4-benzyl-5-hydroxymethylimidazole.

The mixture of an epoxy resin and a semi-crystalline polyester contains an epoxy resin; a semi-crystalline polyester; a heat-activatable curing agent or a light-activatable curing agent; and a curing accelerator or photosensitizer as an optional component. The epoxy resin, heat-activatable curing agent, light-activatable curing agent, curing accelerator and photosensitizer may be those described above for the mixture of an epoxy resin and a polyacrylate. The semi-crystalline polyester shows a crystalline melting point when measured by a differential scanning calorimeter (DSC) and, for example, shows a maximum melting point of about 200° C. The semi-crystalline polyester may further contain a nucleating agent such as microcrystalline wax so as to adjust the rate of crystallization at a given temperature, and examples of the nucleating agent include Unilin (trade name) 700 available from Petrolite Corp.

The polyester includes hydroxyl group-terminated and carboxyl group-terminated polyesters which are semi-crystalline at room temperature. Other functional groups which may be present are —NH, —CONH, —NH₂, —SH, an anhydride group, a urethane group and an oxirane group. The polyester is solid at room temperature, and the number average molecular weight thereof may be from about 7,500 to 200,000, from about 10,000 to 50,000, or from about 15,000 to 30,000.

The polyester component useful in the embodiment of the present disclosure is composed of a reaction product of an aliphatic dicarboxylic acid such as succinic acid, glutaric acid, adipic acid, pimelic acid, suberic acid, azelaic acid, sebacic acid, 1,12-dodecanedioic acid, 1,4-cyclohexanedicarboxylic acid, 1,3-cyclopentanedicarboxylic acid, 2-methylsuccinic acid, 2-methylpentanedioic acid and 3-methylhexanedioic acid, or an aromatic dicarboxylic acid such as terephthalic acid, isophthalic acid, phthalic acid, 4,4′-benzophenonedicarboxylic acid, 4,4′-diphenylmethanedicarboxylic acid, 4,4′-diphenylthioetherdicarboxylic acid and 4,4′-diphenylaminedicarboxylic acid, (or an anhydride or diester thereof), with a diol such as ethylene glycol, 1,3-propylene glycol, 1,2-propylene glycol, 1,4-butanediol, 1,3-butanediol, 1,5-pentanediol, 2-methyl-2,4-pentanediol, 1,6-hexanediol, cyclobutane-1,3-di(2′-ethanol), cyclohexane-1,4-dimethanol, 1,10-decanediol, 1,12-dodecanediol, neopentyl glycol and poly(oxyalkylene) glycol.

Examples of the hydroxyl group-terminated polyester material include Dynapol (trade name) 5330, Dynapol (trade name) 51401, Dynapol (trade name) 51402, Dynapol (trade name) S1358, Dynapol (trade name) 51359, Dynapol (trade name) 51227 and Dynapol (trade name) 51229 available from Huls America, Inc.

The urethane-based reactive hot-melt composition is, for example, a hot-melt composition containing a moisture-curable urethane-based material. Such a composition contains one or more of polyisocyanates (for example, diisocyanates such as 4,4′-diphenylmethylene diisocyanate, toluene diisocyanate, isophorone diisocyanate and hexamethylene diisocyanate, or an isocyanate derivative thereof), one or more of polyfunctional hydroxyl group-containing materials which do not inhibit the moisture curing reaction (e.g., polyester including polycaprolactone or polyether polyol), and optionally a catalyst for the moisture curing reaction (e.g., dibutyltin dilaurate).

The above-described adhesive material such as epoxy resin-polyacrylate mixture, epoxy resin-semi-crystalline polyester mixture and urethane-based reactive hot-melt composition may further contain a hollow microbubble of glass or polymer, an inorganic filler, a pigment, a fiber, a woven fabric, a non-woven fabric, a foaming agent, an antioxidant, a stabilizer, a plasticizer, a colorant, a flameproofing agent, a chain transfer agent, a flow control agent, a viscosity control agent, an adhesion promoter (e.g., silane coupling agent), etc.

Among the above-described materials, the epoxy resin-polyacrylate mixture is rapidly curable and has good material compatibility with the core layer. Furthermore, the epoxy resin-polyacrylate mixture is usable also for adhesion of a light-opaque material, etc.

The adhesive sheet, which is a laminate of a core layer and a curable adhesive layer each comprising the above-described materials, can realize excellent adhesion in terms of both low temperature impact resistance and high temperature adhesiveness. The core layer and curable adhesive layer each may vary in the thickness depending on the low temperature impact resistance required, adhesive force to the adherend, etc. The thickness of the core layer may be generally about 0.05 mm or more or about 0.1 mm or more and about 10 mm or less or about 5 mm or less. When the thickness of the core layer is in this range, satisfactory low temperature impact resistance can be exerted. Also, the thickness of the curable adhesive layer may be generally about 0.005 mm or more or about 0.01 mm or more and about 5 mm or less or about 2 mm or less. When the thickness of the curable adhesive layer is in this range, sufficiently high-strength adhesion to an adherend can be achieved.

A “Low Temperature Impact Resistance Test” which is described later in Examples is used herein as an index indicative of the low temperature impact resistance of the adhesive sheet. An adhesive sheet produced for this test is evaluated according to the procedure described in “Low Temperature Impact Resistance Test” and when the impact angle at 0° C. is about 50° or more, this is regarded as practical low temperature impact resistance. Furthermore, when the impact angle at −30° C. is about 50° or more, this is regarded as good low temperature impact resistance. A larger impact angle indicates better low temperature impact resistance.

Also, “Measurement of Shear Bond Strength” which is described later in Examples is used herein as one index indicative of the high temperature adhesiveness of the adhesive sheet. When the shear bond strength of the adhesive sheet produced for this test is about 1.3 MPa or more at 80° C., this is regarded as practical high temperature adhesiveness, and when about 1.5 MPa or more, this is regarded as good shear bond strength.

The value of the shear bond strength is, in the case where the adherend used for the test is not broken, a smallest value out of (i) the force necessary for cohesion failure of the core layer and/or cured adhesive layer, (ii) the force necessary for delamination between the core layer and the cured adhesive layer, and (iii) the force necessary for interfacial separation between the adherend used for the test and the cured adhesive layer. Accordingly, depending on the combination of core layer and curable adhesive layer used for the adhesive sheet, when a shear force is applied to the adhesive sheet, delamination between the core layer and the cured adhesive layer may occur earlier than the cohesion failure, and thus sufficiently high shear bond strength may not be practically exerted. In such a case, the interlayer adhesive force between the core layer and the cured adhesive layer can be effectively increased, for example, by reacting, as described above, a polar group-containing monomer, particularly a hydroxyl group-containing monomer, with a polymer having a urethane acrylate unit of the core layer, thereby introducing a polar group-containing unit into the polymer.

In addition to or in place of introducing a polar group-containing unit into the polymer of the core layer, as shown in FIG. 2, a primer layer 40 may be provided between the core layer 20 and the curable adhesive layer 30, so that the interlayer adhesive force of the core layer to the cured adhesive layer can be increased when the adhesive sheet is used. As for the material used in the primer layer, a general primer agent for urethane adhesive, such as isocyanate-based and epoxy-based primers, or a primer agent employed for other plastics can be used, and examples thereof include K500 (trade name, produced by Sumitomo 3M Ltd.). Other than these, the interlayer adhesive force between the core layer and the cured adhesive layer may also be increased by generating a polar group on the core layer surface through a surface modification treatment such as corona treatment, plasma treatment and flame treatment.

The delamination force between the core layer and the cured adhesive layer, as measured by “Measurement of Interlayer Adhesive Force” described later in Examples, is practically about 3.0 N/cm or more and when it is about 5.0 N/cm or more, this indicates that good interlayer adhesive force is established.

The adhesive sheet can be used by fixing, before or after curing of the curable adhesive layer, an article to the second major surface of the core layer, i.e., the surface where the curable adhesive layer is not provided. In this case, an adhesive layer is provided on the second major surface of the core layer or on the attaching surface of an article and the article is adhered to the adhesive sheet, whereby the article can be fixed on the second major surface side of the core layer of the adhesive sheet.

Examples of the adhesive layer which can be used include the above-described epoxy resin-polyacrylate mixture; an epoxy resin-semi-crystalline polyester mixture; a polyolefin adhesive (for example, polyethylene, polypropylene, polyhexene, polyoctene and a mixture or copolymer thereof); an ethylene-vinyl acetate adhesive; an epoxy-based adhesive; a silicone adhesive; a silicone-acrylate adhesive; an acrylic adhesive; a rubber-based adhesive (e.g., butyl rubber); and an adhesive mainly comprising a thermoplastic elastomer block copolymer (for example, a styrene-butadiene-styrene, styrene-isoprene-styrene or styrene-ethylene-propylene-styrene block copolymer). A primer agent for promoting the adhesion may be applied to the attaching surface of the article and/or the second major surface of the core layer.

Also, as shown in FIG. 3, the adhesive sheet 10 may be a three-layer laminate where a first curable adhesive layer 30 and a second curable adhesive layer 31 are stacked on the first major surface 21 and the second major surface 22 of the core layer 20, respectively. By taking such a construction, two adherends can be adhered to the first major surface and the second major surface of the core layer, respectively, in the same curing step or continuous curing steps to fix these two adherends by the adhesive sheet therebetween. The first curable adhesive layer and the second curable adhesive layer may be formed of the same material or different materials depending on the adhesive force, etc., required for respective adherends. In the case where both the first and second curable adhesive layers 30 and 31 are formed of substantially the same material, curing can be performed in the same curing step and excellent production efficiency is achieved.

Furthermore, as shown in FIG. 4, in order to protect the exposed surface of the curable adhesive layer 30 of the adhesive sheet 10, a release liner 50 may be provided on the exposed surface. The release liner may be, for example, a plastic film such as polyolefin (e.g., polyethylene, polypropylene) and polyester (e.g., polyethylene terephthalate), or a paper or plastic film with the surface being treated with a release material such as silicone release agent, fluorine-based release agent and long-chain alkyl release agent. In the case where a curable adhesive layer is disposed on both surfaces of the core layer, the release liner may be applied to both surfaces.

The adhesive sheet can be produced by various methods.

For example, in the case where a polymer having an urethane acrylate unit is prepared by photopolymerization using a photopolymerization initiator and used for the core layer, a mixture of constituent raw materials of the polymer is subjected to deaeration and/or blowing of an inert gas such as nitrogen and the mixture is then disposed between a pair of ultraviolet-transparent release liners (for example, silicone-treated biaxially stretched PET film). Subsequently, an ultraviolet light with an intensity of about 1 to 30 mW/cm² is irradiated on one surface or both surfaces of the release liner. The irradiation energy amount necessary for the polymerization of the composition varies depending on the thickness and chemical structure but is usually from about 200 to 2,000 mJ. In this way, a core layer sandwiched by a pair of release liners is formed. One or both of the release liners may be removed, if desired. Alternatively, in the case where a polymer having a urethane acrylate unit is prepared by thermal polymerization using a thermal polymerization initiator and used for the core layer, the composition sandwiched by release liners is heated using a convection oven, a hot plate, an IR lamp, etc., in place of ultraviolet irradiation, whereby the core layer can be formed.

As regards the curable adhesive layer, for example, the constituent raw materials of the curable adhesive layer are melted at a temperature low enough to avoid activating the heat-activatable curing agent or decomposing the light-activatable curing agent and stirred in an appropriate mixing vessel (e.g., batch mixer, extruder) and then, the mixture can be shaped into a desired dimension by various methods. Examples of the shaping method include coating on a release liner by using a heated knife coater, formation of a strip by using a die extruder, formation of a sheet by extrusion and calendering, and formation of a flat sheet by extrusion utilizing a flat die. The strip or flat sheet may be extruded either onto a release liner or directly onto a separately produced core layer. Also, a surface structure such as irregularity, groove or protrusion may be imparted to the surface of the curable adhesive layer by using an emboss roll, etc.

In the case where the curable adhesive layer is composed of an epoxy resin-polyacrylate mixture, similarly to the above-described core layer, the curable adhesive layer may be formed by disposing a mixture of constituent raw materials containing a prepolymer and/or a monomer between a pair of release liners, and polymerizing the (meth)acrylic group by irradiation of radiation or heating.

The core layer and curable adhesive layer which are previously produced as above are laminated under pressure, whereby the adhesive sheet according to the embodiment of the present disclosure can be produced. As described above, the interlayer adhesive force between the core layer and the curable adhesive layer may be enhanced by providing a primer layer between the core layer and the curable adhesive layer. For example, the primer layer can be formed by extrusion-coating or coating a primer agent on a previously produced curable adhesive layer or core layer and, if desired, drying the primer layer. Thereafter, the core layer and the adhesive layer are stacked by arranging the layers so as to sandwich the primer layer and the stack is pressed at a given temperature, whereby an adhesive sheet having a primer layer provided between the core layer and the curable adhesive layer can be produced.

In the case where both the core layer and the curable adhesive layer are produced using the same polymerization system, i.e., the constituent raw materials of both the core layer and the curable adhesive layer contain either a photopolymerization initiator or a thermal polymerization initiator, the constituent raw materials of the core layer and the constituent raw materials of the curable adhesive layer are co-extruded using T-dies in parallel by arranging the long sides to lie adjacent to each other and at the same time, the co-extruded materials in the vicinity of the outlet orifices are either irradiated with radiation or heated, whereby the adhesive sheet according to the embodiment of the present disclosure where the core layer and the curable adhesive layer are simultaneously polymerized and laminated may be produced.

Alternatively, a mixture of constituent raw materials of the curable adhesive layer may be coated on a previously produced core layer, or a mixture of constituent raw materials of the core layer may be coated on a previously produced curable adhesive layer. Furthermore, a mixture of constituent raw materials of either the curable adhesive layer or the core layer may be coated on a release liner, and a previously produced core layer or curable adhesive layer may be placed thereon. A mixture of constituent raw materials of the core layer may be sandwiched by two previously produced curable adhesive layers to produce a three-layer laminate. In the case where the mixture coated contains a photopolymerization initiator or a thermal polymerization initiator, as described above, the coating is irradiated with radiation or heated, whereby the core layer and/or the curable adhesive layer are produced. In the case where constituent raw materials of the core layer are coated on a previously produced curable adhesive layer and then, the constituent raw materials of the core layer are polymerized, the polymerization system of the core layer is preferably selected to avoid activating and/or decomposing the curing system, i.e., the heat-activatable curing agent or light-activatable curing agent, contained in the curable adhesive layer. For example, in the case of coating on a heat-curable adhesive layer, the core layer is preferably produced using constituent raw materials containing a photopolymerization initiator and on the contrary, in the case of coating on a photo-curable adhesive layer, the core layer is preferably produced using constituent raw materials containing a thermal polymerization initiator. As described above, a primer layer may be provided on the curable adhesive layer or core layer, if desired.

On the thus-produced adhesive sheet, the above-described release liner may be applied as needed for the purpose of protecting the exposed surface of the curable adhesive layer and, if desired, the core layer. The adhesive sheet is processed, for example, into a roll by applying a release liner on the curable adhesive layer and winding the sheet around a core, into a tape by slitting the roll to a small width, or into a sheet by punching the sheet according to the shape of the adherend, and is provided in various shapes.

The adhesive sheet is adhered to an adherend by bringing the curable adhesive layer into contact with the attaching surface of the adherend and then either curing the curable adhesive layer by heating or irradiating with radiation, or allowing the curable adhesive layer to be gradually cured by moisture in the atmosphere. In the case where the curable adhesive layer is not tacky at room temperature, the curable layer may be softened under heating at an appropriate temperature to enhance the adherence between the adherend surface and the curable adhesive layer. Also, a pressure may be applied to the adhesive sheet simultaneously with heating so as to conform the curable adhesive layer to the shape of the adherend surface.

The adherend to which the above-described adhesive sheet is applied includes glass, metal, plastic, wood and ceramic substrates. Representative plastic substrates are polyvinyl chloride, ethylene-propylene-diene rubber, polyurethanes, polymethyl methacrylate, an engineering thermoplastic resin (e.g., polyphenylene oxide, polyether ether ketone, polycarbonate), and a thermoplastic elastomer including a thermoplastic elastomeric olefin. In particular, the adhesive sheet according to the embodiment of the present disclosure is useful for the adhesion of a glass substrate or a metal or plastic substrate. For example, the adhesive sheet is suitably used for the purpose of adhering a glass plate such as automotive side glass or rear glass to a metal or plastic-made vehicle body attachment part or a vehicle body component such as frame.

### EXAMPLES

Raw materials used in Examples and Comparative Examples are shown together in Table 1 below.

TABLE 1
List of Raw Materials

| Trade | | | |
|---|---|---|---|
| Name or | | | |
| Abbrevia- | | | |
| tion | Chemical Name | Manufacturer | Remarks |
| BA | n-butyl acrylate | Nippon Shokubai | Tg = −56° C.¹⁾ |
| DMAA | N,N-dimethyl- | Kohjin | Tg = 120° C.¹⁾ |
| | acrylamide | | |
| 2EHA | 2-ethylhexyl acrylate | Nippon Shokubai | Tg = −70° C.¹⁾ |
| HEA | 2-hydroxyethyl | Osaka Organic | Tg = −15° C.¹⁾ |
| | acrylate | Chemical Industry | |
| HPA | 2-hydroxypropyl | Osaka Organic | Tg = −7° C.¹⁾ |
| | acrylate | Chemical Industry | |
| 4HBA | 4-hydroxybutyl | Osaka Organic | Tg = −32° C.¹⁾ |
| | acrylate | Chemical Industry | |
| AA | acrylic acid | Toagosei | Tg = 87° C.¹⁾ |
| PEA | 2-phenoxyethyl | Osaka Organic | Tg = −22° C.¹⁾ |
| | acrylate | Chemical Industry | |
| UA1083F | urethane acrylate with | The Nippon | Tg = −20° C.²⁾ |
| | polycaprolactone | Synthetic | |
| | backbone | Chemical Industry | |
| UV3300B | urethane acrylate with | The Nippon | Tg = −61° C.²⁾ |
| | polytetramethylene | Synthetic | |
| | glycol backbone | Chemical Industry | |
| UV3700B | urethane acrylate with | The Nippon | Tg = −43° C.²⁾ |
| | polypropylene glycol | Synthetic | |
| | backbone | Chemical Industry | |
| EB230 | urethane acrylate with | Daicel Chemical | Tg = −42° C.²⁾ |
| | polypropylene glycol | Industries | |
| | backbone | | |
| EB270 | urethane acrylate with | Daicel Chemical | Tg = 21° C.²⁾ |
| | polypropylene glycol | Industries | |
| | backbone | | |
| Irgacure | 2,2-dimethoxy-1,2- | Ciba Japan | photopolymer- |
| 651 | diphenylethan-1-one | | ization |
| | | | initiator |
| HDDA | 1,6-hexanediol | Shin-Nakamura | acrylate |
| | diacrylate | Chemical | crosslinking |
| | | | agent |
| YD-128 | bisphenol A-type | Tohto Kasei | |
| | epoxy resin | | |
| Epon 1001 | bisphenol A-type | Japan Epoxy | |
| | epoxy resin | Resins | |
| DICY | dicyandiamide (part | Asahi Denka | heat- |
| | No.: EH3636AS) | | activatable |
| | | | curing agent |
| 2MZ-A-PW | 2,4-diamino-6-[2′- | Shikoku Corp. | curing |
| | methylimidazolyl-(1′)]- | | accelerator |
| | ethyl-s-triazine | | |
| R-972 | silicon dioxide | Nippon Aerosil | silica filler |
| RT8002 | acryl foam tape | Sumitomo 3M | acrylic |
| | | | adhesive tape |

1) The Tg value was extracted from the catalogue of each company.
2) The Tg value was measured as follows. 0.1 Parts by weight of Irgacure 651 was mixed with 100 parts by weight of urethane acrylate oligomer, and the mixture was sandwiched by two sheets of 50 μm-thick release-treated PET film and cured using a UV-A lamp manufactured by Sylvania by irradiating an ultraviolet ray with an energy amount of 1,200 mJ. The obtained sample was measured for the peak temperature of loss tangent tan δ (=loss modulus E″/storage modulus E′) in a range from −80° C. to 150° C. (temperature rising rate: 5.0° C./min) by using RSA-III manufactured by Rheometric Scientific, Inc. under the conditions of Mode: Tension and Frequency: 1.0 Hz.

Evaluation methods used are as follows. UV Irradiation was performed using a UV-A lamp manufactured by Sylvania by irradiating an ultraviolet ray with an energy amount of 1,200 mJ.

Measurement of Viscoelastic Characteristics of Adhesive Layer: A mixed solution of Formulation ad01 shown in Table 2 was sandwiched by two sheets of 50 μm-thick release-treated PET film and UV-irradiated to produce a curable adhesive layer of 0.5 mm in thickness. Furthermore, the adhesive layer was heated in an oven at 140° C. for 30 minutes and thereby cured. After removing the release-treated PET film on both surfaces, the obtained sample was measured for the storage modulus E′ (unit: Pa) and the loss tangent tan δ (=loss modulus E″/storage modulus E′) at −40° C., −30° C., −15° C., 0° C. and 80° C. by using RSA-III manufactured by Rheometric Scientific, Inc. under the conditions of Mode: Tension and Frequency: 1.0 Hz. It was found that Tg of Curable Adhesive Layer ad01 is 29.6° C. and E′/tan δ is 3.6×10⁹ Pa/0.02 (at −40° C.), 3.4×10⁹ Pa/0.01 (at −30° C.), 3.16×10⁹ Pa/0.04 (at −15° C.), 2.64×10⁹ Pa/0.08 (at −0° C.) and 7.9×10⁶ Pa/0.219 (at 80° C.)

Measurement of Viscoelastic Characteristics of Core Layer: A mixed solution in accordance with the formulation shown in Table 3 was sandwiched by two sheets of 50 micrometer-thick release-treated PET film and cured by UV irradiation to produce a core layer of 0.2 mm in thickness. After removing the release-treated PET film on both surfaces, the obtained sample was measured for the storage modulus E′ (unit: Pa) and the loss tangent tan δ (=loss modulus E″/storage modulus E′) at −40° C., −30° C., −15° C., 0° C. and 80° C. by using RSA-III manufactured by Rheometric Scientific, Inc. under the conditions of Mode: Tension and Frequency: 1.0 Hz.

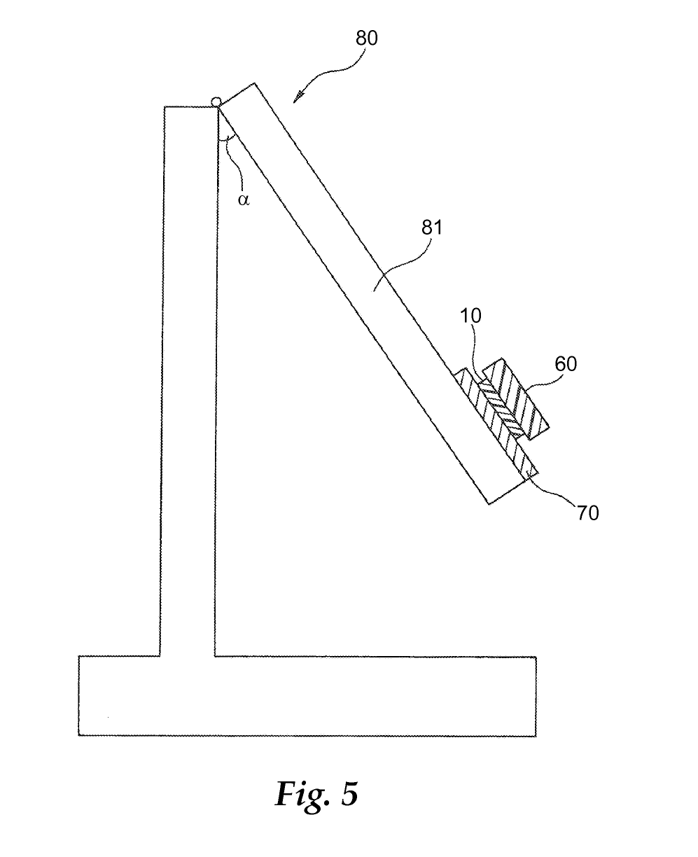

Low temperature impact resistance Test (Impact Angle): FIG. 5 shows a schematic view of a testing device used for the low temperature impact resistance test. On one surface of an adhesive sheet sample 10 produced in accordance with Examples and Comparative Examples and punched into a rectangle having a dimension of 12 mm×25 mm, a degreased PBT (polybutylene terephthalate) plate 60 having a dimension of 21 mm×30 mm and a thickness of 3 mm was affixed. After affixing a 0.8 mm-thick cationic electrodeposition coated plate 70 of 65 mm×150 mm to the opposite surface of the sample, the sheet sample was heated in an oven at 140° C. for 30 minutes and thereby cured.

The cationic electrodeposition coated plate 70 on which the PBT plate 60 was adhered by the adhesive sheet sample 10 was fixed to the leading end of a 1.2 m-long movable arm 81 of a testing device 80, placed together with the testing device in a constant-temperature test chamber and left standing for 2 hours or more to adjust the conditions. As for the temperature of the constant-temperature test chamber, three levels of 0° C., −15° C. and −30° C. were employed.

The arm 81 of the testing device 80 was lifted, once fixed at a given angle a and then released to allow the cationic electrodeposition coated plate with the arm to swing down like a pendulum and collide against the supporting column of the testing device 80, thereby making an impact on the sheet sample adhering the PBT plate to the cationic electrodeposition coated plate. This operation was repeated 10 times at the same angle and the angle when the PBT plate or sheet sample came off was recorded.

After making an impact 10 times, the angle when lifting the arm was increased by 10° and the above-described procedure was repeated. The test was started from 10° and repeated until the PBT plate or sheet sample came off or the angle reached 90°. In the case of not causing coming off even by making an impact 10 times at 90°, the angle was recorded as 100°.

Five units (n=5) of the same kind of a sheet sample were tested, and the average value of recorded angles was calculated and defined as an impact angle, which was used as an index indicative of low temperature impact resistance. The average angle value exceeding 90° is denoted by “>90” in Table 4.

Measurement of Shear Bond Strength: On both surfaces of a sheet sample produced in accordance with Examples and Comparative Examples and punched into a rectangle having a dimension of 12 mm×25 mm, a degreased cationic electrodeposition coated plate having a dimension of 28 mm×75 mm and a thickness of 0.8 mm was affixed. Thereafter, the sheet sample was heated in an oven at 140° C. for 30 minutes and thereby cured.

The sample was once returned to room temperature, then placed in a tensile tester oven set to 80° C. and heated at this atmosphere temperature for 30 minutes, and two short sides located at remote positions from each other of two cationic electrodeposition plates were fixed on respective jigs of the tensile tester and then pulled to opposite directions (180° directions) at a rate of 50 mm/min to impose a shear force on the sheet sample, whereby the shear bond strength (unit: MPa) was measured.

Measurement of Static Shear Bond Strength: On one surface of a sheet sample produced in accordance with Examples and Comparative Examples and punched into a dimension of 10 mm×10 mm, a degreased PBT (polybutylene terephthalate) plate having a dimension of 27 mm×65 mm and a thickness of 3 mm was affixed. After affixing the opposite surface of the sample to a surface of a hardened glass plate, the sheet sample was heated in an oven at 140° C. for 30 minutes and thereby cured.

The hardened glass plate was vertically fixed in a constant-temperature test chamber at 100° C., and a weight of 2 kg was fixed to the portion not adhered with the sample at the bottom of the PBT plate. The sheet sample was kept in this state for 24 hours and when coming off of the PBT plate was not caused, rated as “passed”.

Measurement of Interlayer Adhesive Force: On both surfaces of a sheet sample produced in accordance with Examples and Comparative Examples and punched into a dimension of 15 mm×50 mm, an anodized aluminum sheet having a dimension of 25 mm×100 mm and a thickness of 200 μm after degreasing was affixed. Thereafter, the sheet sample was heated in an oven at 140° C. for 30 minutes and thereby cured.

The sample was returned to room temperature, and the peel force measured when two short sides located at close positions to each other of front and back two aluminum sheets were fixed on respective jigs of the tensile tester and then pulled to the 180° direction at a rate of 50 mm/min, was defined as the interlayer adhesive force (unit: N/cm).

Because of largest interfacial adhesive force between the anodized aluminum sheet and the cured adhesive layer, in all samples tested, either cohesion failure of the core layer or delamination between the core layer and the cured adhesive layer was observed.

### Examples 1 to 16

Preparation of Curable Adhesive Layer: A mixed solution in accordance with the formulation shown in Table 2 was thoroughly mixed by a mixer and after casting the mixed solution on a 50 micrometer-thick release-treated PET film, another 50 micrometer-thick release-treated PET film was covered on the mixed solution cast. The mixed solution was thus sandwiched by two sheets of release-treated PET film and then UV-irradiated to produce a curable adhesive layer. Another unit was produced through the same procedure. In this way, two units of a curable adhesive layer sandwiched by PET films were prepared. The thickness of the curable adhesive layer was adjusted to 0.2 mm.

TABLE 2
Formulation of Adhesive Layer (numerals are in parts
by weight)

| Raw Materials | | ad01 | ad02 | ad03 |
|---|---|---|---|---|
| Acrylate | BA | 70 | 70 | 70 |
| | DMAA | 30 | 30 | 30 |
| Acrylate crosslinking | HDDA | 0.05 | 0.05 | 0.05 |
| agent | | | | |
| Photopolymerization | Irgacure 651 | 0.14 | 0.14 | 0.14 |
| initiator | | | | |
| Epoxy resin | YD-128 | 60 | 80 | 60 |
| | Epon1001 | 60 | 160 | 30 |
| Heat-activatable | DICY | 9 | 16.8 | 6 |
| curing agent | | | | |
| Curing accelerator | 2MZ-A-PW | 2 | 4 | 1.5 |
| Filler | R-972 | 5 | 12 | 5 |

Preparation of Core Layer and Adhesive Sheet: After preparing two units of a curable adhesive layer produced as above, from which the PET film on one surface was removed, a mixed solution in accordance with the formulation shown in Table 3 was cast on the exposed surface of the curable adhesive layer on one PET film, and another curable adhesive layer with a release-treated PET film was covered thereon such that the exposed surface of the curable adhesive layer came into contact with the mixed solution. The mixed solution was thus sandwiched by two sheets of the curable adhesive layer and then UV-irradiated to cure the core layer, whereby an adhesive sheet having a three-layer laminate structure of a curable adhesive layer being stacked on both surfaces of a core layer (curable adhesive layer/core layer/curable adhesive layer) was produced. The thickness of the core layer was adjusted to 0.2 mm. Accordingly, the total thickness of the adhesive sheet sample was 0.6 mm.

TABLE 3
Formulation of Core Layer

| Raw Materials | | cr01 | cr02 | cr03 | cr04 | cr05 | cr06 | cr07 | cr08 | cr09 | cr10 | cr11 | cr12 | cr13 | cr14 | cr15 | cr16 |
|---|---|---|---|---|---|---|---|---|---|---|---|---|---|---|---|---|---|
| Urethane | UV3700B | | | | | 60 | 40 | 60 | 60 | 60 | | | | 100 | 60 | 60 | 30 |
| acrylate | UV3300B | | | | 60 | | | | | | | | | | | | |
| oligomer | EB230 | | | | | | | | | | 60 | 50 | 40 | | | | |
| | EB270 | 60 | | | | | | | | | | | | | | | |
| | UA1083F | | | 60 | | | | | | | | | | | | | |
| Acrylate | 2EHA | | 92 | | | | | | | | | | | | 40 | | |
| | AA | | 8 | | | | | | | | | | | | | | |
| | HEA | | | | | | | | 40 | | | | | | | | |
| | 4HBA | 40 | | 40 | 40 | 40 | 60 | 20 | | | 40 | 50 | 60 | | | | 70 |
| | DMAA | | | | | | | 20 | | | | | | | | | |
| | PEA | | | | | | | | | | | | | | | 40 | |
| | HPA | | | | | | | | | 40 | | | | | | | |
| Photopolymeriza- | Irgacure | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| tion Initiator | 651 | | | | | | | | | | | | | | | | |

(numerals are in parts by weight)

### Comparative Example 1

Curable Adhesive Layer ad01 was produced in the same manner as above except for changing the thickness to 0.6 mm, and an adhesive sheet where the core layer was substantially composed of only a curable adhesive layer was produced.

### Comparative Examples 2 and 3

Core Layers cr05 and cr07 were produced in the same manner as above except for changing the thickness to 0.6 mm, and sheets each containing no curable adhesive layer and comprising only a core layer were produced.

### Comparative Example 4

In accordance with the formulations shown in Tables 2 and 3, an adhesive sheet having a three-layer laminate structure where Core Layer cr01 of which Tg exceeds 0° C. was sandwiched by Curable Adhesive Layers ad01 was produced.

### Comparative Example 5

An acryl foam tape (part No.: RT8002) was obtained from Sumitomo 3M Ltd. Core Layer cr02 was a heat-curable acryl foam having the composition shown in Table 3.

The evaluation results are shown in Table 4.

TABLE 4
Evaluation Results

| | | | No. | | | | | | |
|---|---|---|---|---|---|---|---|---|---|
| | | Temperature | Example 1 | Example 2 | Example 3 | Example 4 | Example 5 | Example 6 | Example 7 |
| Adhesive Layer A | | | ad01 | ad01 | ad01 | ad01 | Ad01 | ad02 | ad03 |
| Core Layer B | | | cr03 | cr04 | cr05 | cr06 | Cr07 | cr07 | cr07 |
| Adhesive Layer C | | | ad01 | ad01 | ad01 | ad01 | Ad01 | ad02 | ad03 |
| Visco- | Tg (° C.) | | −13.4 | −2.2 | −40.0 | −39.3 | −39.1 | −39.1 | −39.1 |
| elastic | E′ (Pa) | −40° C. | 2.5E+09 | 4.0E+08 | 1.6E+08 | 2.6E+08 | 1.3E+08 | 1.3E+08 | 1.3E+08 |
| Charac- | tan δ | | 0.04 | 0.15 | 0.93 | 0.88 | 1.27 | 1.27 | 1.27 |
| teristics | E′ (Pa) | −30° C. | 1.5E+09 | 2.5E+08 | 3.0E+07 | 4.6E+07 | 1.8E+07 | 1.8E+07 | 1.8E+07 |
| of Core | tan δ | | 0.22 | 0.19 | 0.58 | 0.57 | 0.61 | 0.61 | 0.61 |
| Layer | E′ (Pa) | −15° C. | 5.26E+07 | 8.73E+07 | 6.87E+06 | 1.47E+07 | 8.03E+06 | 8.03E+06 | 8.03E+06 |
| | tan δ | | 1.32 | 0.40 | 0.51 | 0.47 | 0.25 | 0.25 | 0.25 |
| | E′ (Pa) | 0° C. | 6.01E+06 | 1.51E+07 | 2.24E+06 | 2.54E+06 | 5.49E+06 | 5.49E+06 | 5.49E+06 |
| | tan δ | | 0.40 | 0.58 | 0.41 | 0.71 | 0.20 | 0.20 | 0.20 |
| | E′ (Pa) | 80° C. | 6.3E+06 | 7.3E+06 | 1.5E+06 | 1.0E+06 | 1.3E+06 | 1.3E+06 | 1.3E+06 |
| | tan δ | | 0.003 | 0.002 | 0.033 | 0.049 | 0.124 | 0.124 | 0.124 |
| Impact Angle | | −30° C. | 48 | 42 | 58 | 72 | 86 | 76 | 74 |
| (average of | | −15° C. | 52 | 52 | 52 | 62 | 78 | 62 | 78 |
| n = 10) | | 0° C. | 70 | 66 | 80 | 62 | 78 | 56 | >90 |
| Interlayer Adhesive | | | 5.2 | 9.2 | 9.6 | 9.2 | 12.0 | 6.7 | 26.3 |
| force (N/cm) | | | | | | | | | |
| Shear Bond | | room | 5 | 8.7 | 8.0 | 8.0 | 13.3 | 12.7 | 12.3 |
| Strength (MPa) | | temperature | | | | | | | |
| | | 80° C. | 1.4 | 2.6 | 4.0 | 1.5 | 3.9 | 5.8 | 2.6 |
| Static Shear | | 80° C. | passed | passed | passed | passed | passed | passed | passed |
| Bond Strength | | 24 h | | | | | | | |
| | | | No. | | | | | | |
| | | Temperature | Example 8 | Example 9 | Example 10 | Example 11 | Example 12 | Example 13 | Example 14 |
| Adhesive Layer A | | | ad01 | ad01 | ad01 | ad01 | ad01 | ad01 | ad01 |
| Core Layer B | | | cr08 | cr09 | cr10 | cr11 | cr12 | cr13 | cr14 |
| Adhesive Layer C | | | ad01 | ad01 | ad10 | ad01 | ad01 | ad01 | ad01 |
| Visco- | Tg (° C.) | | −42.0 | −42.5 | −14.0 | −15.1 | −10.4 | −43.3 | −43.2 |
| elastic | E′ (Pa) | −40° C. | 5.7E+07 | 6.5E+07 | 4.5E+08 | 5.7E+08 | 9.2E+08 | 1.3E+07 | 1.2E+07 |
| Charac- | tan δ | | 1.28 | 1.18 | 0.54 | 0.47 | 0.35 | 1.28 | 1.58 |
| teristics | E′ (Pa) | −30° C. | 1.4E+07 | 1.6E+07 | 1.0E+08 | 1.3E+08 | 3.0E+08 | 4.4E+06 | 2.8E+06 |
| of Core | tan δ | | 0.56 | 0.55 | 0.52 | 0.50 | 0.39 | 0.54 | 0.78 |
| Layer | E′ (Pa) | −15° C. | 6.12E+06 | 7.14E+06 | 1.55E+07 | 1.48E+07 | 3.08E+07 | 2.27E+06 | 1.27E+06 |
| | tan δ | | 0.28 | 0.30 | 0.62 | 0.80 | 0.89 | 0.19 | 0.28 |
| | E′ (Pa) | 0° C. | 3.89E+06 | 4.29E+06 | 3.80E+06 | 3.49E+06 | 3.50E+06 | 1.77E+06 | 9.73E+05 |
| | tan δ | | 0.25 | 0.27 | 0.39 | 0.38 | 0.61 | 0.16 | 0.17 |
| | E′ (Pa) | 80° C. | 1.2E+06 | 9.7E+05 | 3.3E+06 | 3.2E+06 | 2.2E+06 | 1.5E+06 | 8.0E+05 |
| | tan δ | | 0.041 | 0.061 | 0.002 | 0.005 | 0.009 | 0.039 | 0.038 |
| Impact Angle | | −30° C. | 78 | 74 | 60 | 62 | 66 | >90 | 82 |
| (average of | | −15° C. | 82 | 90 | 52 | 52 | 50 | >90 | 80 |
| n = 10) | | 0° C. | 72 | >90 | 58 | 64 | 58 | >90 | 86 |
| Interlayer Adhesive | | | 8.9 | 16.3 | 11.5 | 6.9 | 6.6 | 2.9 | 1.1 |
| force (N/cm) | | | | | | | | | |
| Shear Bond | | room | 6.8 | 9.6 | 12.9 | 7.7 | 8.0 | 0.9¹⁾ | 0.4¹⁾ |
| Strength (MPa) | | temperature | | | | | | | |
| | | 80° C. | 1.7 | 2.5 | 1.7 | 2.0 | 2.3 | 0.5¹⁾ | 0.0¹⁾ |
| Static Shear | | 80° C. | passed | passed | passed | passed | passed | not | not |
| Bond Strength | | 24 h | | | | | | passed¹⁾ | passed¹⁾ |
| | | | No. | | | | | | |
| | | | Example | Example | Comparative | Comparative | Comparative | Comparative | Comparative |
| | | Temperature | 15 | 16 | Example 1 | Example 2 | Example 3 | Example 4 | Example 5 |
| Adhesive Layer A | | | ad01 | ad01 | ad01 | cr05 | cr07 | ad01 | ad01 |
| Core Layer B | | | cr15 | cr16 | ad01 | cr05 | cr07 | cr01 | cr02 |
| Adhesive Layer C | | | ad01 | ad01 | ad01 | cr05 | cr07 | ad01 | ad01 |
| Visco- | Tg (° C.) | | −37.7 | −8.6 | 29.6 | −40.0 | −39.1 | 3.4 | −7.6 |
| elastic | E′ (Pa) | −40° C. | 4.6E+08 | 4.8E+08 | 3.6E+09 | 1.6E+08 | 1.3E+08 | 3.0E+09 | 5.4E+08 |
| Charac- | tan δ | | 0.52 | 0.50 | 0.02 | 0.93 | 1.27 | 0.05 | 0.39 |
| teristics | E′ (Pa) | −30° C. | 1.1E+08 | 1.6E+08 | 3.4E+09 | 3.0E+07 | 1.8E+07 | 2.3E+09 | 1.5E+08 |
| of Core | tan δ | | 0.43 | 0.44 | 0.01 | 0.58 | 0.61 | 0.11 | 0.64 |
| Layer | E′ (Pa) | −15° C. | 3.37E+07 | 1.71E+07 | 3.16E+09 | 6.87E+06 | 8.03E+06 | 8.13E+08 | 2.17E+07 |
| | tan δ | | 0.35 | 0.92 | 0.04 | 0.51 | 0.25 | 0.31 | 0.94 |
| | E′ (Pa) | 0° C. | 1.17E+07 | 2.23E+06 | 2.64E+09 | 2.24E+06 | 5.49E+06 | 6.37E+07 | 4.52E+06 |
| | tan δ | | 0.38 | 0.78 | 0.08 | 0.41 | 0.20 | 0.98 | 0.93 |
| | E′ (Pa) | 80° C. | 7.7E+05 | 7.9E+05 | 7.9E+06 | 1.5E+06 | 1.3E+06 | 6.5E+06 | 5.1E+05 |
| | tan δ | | 0.033 | 0.059 | 0.219 | 0.033 | 0.124 | 0.001 | 0.261 |

| | | | | | | | | |
|---|---|---|---|---|---|---|---|---|
| Impact Angle | −30° C. | 76 | 58 | 35 | ND | ND | 40 | 50 |
| (average of | −15° C. | 66 | 64 | 30 | ND | ND | 40 | 50 |
| n = 10) | 0° C. | 82 | 68 | 38 | ND | ND | 44 | 58 |
| Interlayer Adhesive | | 12.6 | 5.3 | — | — | — | 12.9 | 6.4 |
| force (N/cm) | | | | | | | | |
| Shear Bond | room | 8.0 | 8.0 | — | 0.0 | 0.0 | 11.0 | 2.0²⁾ |
| Strength (MPa) | temperature | | | | | | | |
| | 80° C. | 1.4 | 1.3 | — | 0.0 | 0.0 | 2.5 | 0.5²⁾ |
| Static Shear | 80° C. | passed | passed | passed | not | not | passed | not |
| Bond Strength | 24 h | | | | passed | passed | | passed²⁾ |

(ND indicates that the measurement was impossible)
¹⁾The core layer did not cause cohesion failure, but delamination between adhesive layer and core layer occurred.
²⁾The core layer caused cohesion failure.

1. An adhesive sheet comprising:
a core layer having first and second major surfaces, the core layer containing a polymer having a urethane acrylate unit and the glass transition temperature (Tg) of said polymer being less than 0° C.;
a first adhesive layer stacked on the first major surface of said core layer, with said first adhesive layer being curable; and
a second adhesive layer stacked on the second major surface of said core layer.

2. The adhesive sheet as claimed in claim 1, wherein the storage modulus E of said polymer is from 5.0×10⁵ to 3.0×10⁸ Pa at 0° C. and from 5.0×10⁵ to 3.0×10⁸ Pa at 80° C. and the loss tangent tan δ of said polymer is 0.15 or more at 0° C. and 0.25 or less at 80° C.

3. The adhesive sheet as claimed in claim 1, wherein said polymer contains a polymeric backbone selected from the group consisting of polyether, polyester, polycarbonate and a combination thereof.

4. The adhesive sheet as claimed in claim 1, wherein said polymer further contains a polar group-containing unit in an amount of 20 to 70% by weight based on the weight of the polymer.

5. The adhesive sheet as claimed in claim 1, wherein said first adhesive layer is a heat-curable adhesive layer.

6. The adhesive sheet as claimed in any one of claim 1, wherein said second adhesive layer is a heat-curable adhesive layer.

7. An article comprising an attaching surface adhered to the second adhesive layer of said adhesive sheet as claimed in claim 1.

8. The article of claim 7 in combination with an automobile, wherein said article is adhered to said automobile by said first adhesive layer of said adhesive sheet.

9. The adhesive sheet as claimed in claim 2, wherein said first adhesive layer is a heat-curable adhesive layer.

10. The adhesive sheet as claimed in claim 3, wherein said first adhesive layer is a heat-curable adhesive layer.

11. The adhesive sheet as claimed in claim 4, wherein said first adhesive layer is a heat-curable adhesive layer.

12. The adhesive sheet as claimed in claim 2, wherein said second adhesive layer is a heat-curable adhesive layer.

13. The adhesive sheet as claimed in claim 3, wherein said second adhesive layer is a heat-curable adhesive layer.

14. The adhesive sheet as claimed in claim 4, wherein said second adhesive layer is a heat-curable adhesive layer.

15. The adhesive sheet as claimed in claim 5, wherein said second adhesive layer is a heat-curable adhesive layer.

16. An article comprising an attaching surface adhered to the second adhesive layer of said adhesive sheet as claimed in claim 2.

17. An article comprising an attaching surface adhered to the second adhesive layer of said adhesive sheet as claimed in claim 3.

18. An article comprising an attaching surface adhered to the second adhesive layer of said adhesive sheet as claimed in claim 4.

19. An article comprising an attaching surface adhered to the second adhesive layer of said adhesive sheet as claimed in claim 5.

20. An article comprising an attaching surface adhered to the second adhesive layer of said adhesive sheet as claimed in claim 6.
